(19) United States
(12) Patent Application Publication
(10) Pub. No.: US 2021/0101237 A1
(43) Pub. Date: Apr. 8, 2021

(54) Tool Changing System of a Machining Center and Method for Controlling the Same

(71) Applicants: Hyundai Motor Company, Seoul (KR); KIA Motors Corporation, Seoul (KR)

(72) Inventors: Moo Hyun Kim, Ulsan (KR); Jekwang Cho, Ulsan (KR); Ji Won Yu, Ulsan (KR)

(21) Appl. No.: 16/836,270

(22) Filed: Mar. 31, 2020

(30) Foreign Application Priority Data
Oct. 7, 2019 (KR) 10-2019-0123900

(51) Int. Cl. B23Q 3/155; B23Q 3/157

(52) U.S. Cl. CPC B23Q 3/15539; B23Q 3/1554; B23Q 3/15546; B23Q 3/1572; B23Q 3/15553

(57) ABSTRACT

A tool changing system of a machining center for machining a workpiece of a vehicle includes a machining unit including a jig portion for loading the workpiece and a tool loading device for loading a tool for machining the workpiece, a first magazine for storing a plurality of first tools, a second magazine for storing a plurality of second tools, and a controller configured to manage changing of the first tool between the machining unit and the first magazine and changing of the second tool between the machining unit.

### CROSS-REFERENCE TO RELATED APPLICATIONS

This application claims priority to and the benefit of Korean Patent Application No. 10-2019-0123900 filed in the Korean Intellectual Property Office on Oct. 7, 2019, the entire contents of which are incorporated herein by reference.

### FIELD

The present disclosure relates to a tool changing system of a machining center and methods for controlling the same.

### BACKGROUND

In general, a machining center refers to a machining assembly, which is a system that is capable of performing almost all operations related to machining.

The machining center differs from general computer numerical control (CNC) milling in that tool replacement is possible in the machining center.

Although the CNC milling is also possible for manual tool replacement, but the machining center has a merit that a required tool can be automatically replaced by selecting the required tool from the magazine during machining.

Therefore, the machining center provides a merit of shortening the machining time by reducing the time required for tool replacement.

Most of the machining performed in such a machining center is hole machining.

For example, a machining center is typically used for drilling (i.e., forming a hole), tapping (i.e., threading a hole), boring (i.e., enlarging a hole), and reaming (i.e., smoothing a hole).

Therefore, it is necessary to replace tools with appropriate tools for a process to proceed.

That is, the machining center automatically machines a workpiece by a scheduled sequence while replacing required tools from among various tools being arranged in a magazine.

Since various types of tools should be selectively changed in order for various machining processes to be automatically finished, such a machining center is required to have an automatic tool changer (ATC) that may replace a tool mounted on the spindle with a tool stored in the magazine when the tool mounted on a spindle finishes a machining process.

The technology of continuously machining a workpiece continuously while rapidly changing tools on the spindle is also an important factor for improving productivity.

Therefore, in order to further improve the productivity in the machining center, it is required to develop a technology for improving the structure of the spindle and the corresponding tool changer so that continuous machining of parts can be performed while changing tools more quickly and efficiently.

The above information disclosed in this section is only for enhancement of understanding of the disclosure and therefore it may contain information that does not form the prior art that is already known in this country to a person of ordinary skill in the art.

### SUMMARY

An exemplary tool changing system of a machining center for machining a workpiece of a vehicle include a machining unit including a jig portion for loading the workpiece and a tool loading device for loading a tool for machining the workpiece, a first magazine for storing a plurality of first tools, a second magazine for storing a plurality of second tools, and a controller configured to manage changing of the first tool between the machining unit and the first magazine and changing of the second tool between the machining unit.

Each of the first tools and the second tools may be respectively assigned an identification number. The second tools may have lengths larger than the first tools.

The tool loading device of the machining unit may be disposed above the jig portion, and may include an operation head for mounting a machining tool from among the plurality of first and second tools, and a spindle for holding the operation head rotatably and slidably and disposed on a base frame rotatably and slidably.

The first magazine may include a first housing disposed above the machining unit, a plurality of holding members for holding the plurality of first tools, disposed inside the first housing by a predetermined spacing, and revolving in a horizontal plane by a conveyor belt, a first servo-motor for applying a driving torque to the conveyor belt, and a rotatable changing device disposed in front of the first housing, disposed between the holding member and the tool loading device, and configured to replace tools between the tool loading device and the holding members.

A central portion of the rotatable changing device may be rotatably mounted in the first housing. A gripper for gripping the first tool may be mounted to both ends of the rotatable changing device.

The second magazine may include a second housing disposed lateral to the machining unit and having a first opening and a second opening at opposite sides, a tool seating part at a side of the second housing corresponding to the first opening and allowing the second tool to get into the second housing, first and second rotation plates disposed in parallel to each other in an interior of second housing, and configured to clamp both ends of a second tool supplied from the tool seating part and to rotate together with the clamped second tool, and a second servo-motor having a rotation rod connected to centers of the first and second rotation plates to apply a rotation torque to the first and second rotation plates.

The second housing may form a space portion formed by the second opening to allow entrance of the tool loading device to change tools.

The tool seating part may include a lower plate installed at the first opening of the second housing, an upper plate slidably mounted on the lower plate, and a fixing part formed on an upper surface of the upper plate, and configured to hold an end of a head portion of the second tool.

The fixing part may include a catching portion to rotate to tightly hold the head portion of the second tool.

A plurality of first clamping members may be mounted at a predetermined interval along a circumference of the first rotation plate. A plurality of second clamping members may be mounted at predetermined intervals along a circumference of the second rotation plate such that each second clamping member is rotatably mounted on the second rotation plate through a connection bracket.

Each of the first and second clamping members may include finger members to clamp the second tool.

The second magazine may include a plurality of proximity sensors mounted on the second rotation plate, at respective positions corresponding to the second clamping members, so as to determine whether the second tool is mounted, and

The proximity sensor may be configured to send a signal regarding whether the second tool is clamped or not, to the controller by wireless communication.

The second magazine may further include a rotation cover rotatably disposed in an interior of the second housing and configured to open and close the second opening.

An exemplary method is for controlling a tool changing system of a machining center having a machining unit performing a machining work and having first and second magazines respectively storing first and second tools, and the exemplary method includes loading a workpiece to the machining unit, identifying an identification number of a mounted tool mounted on the machining unit, identifying an identification number of a required tool for machining the workpiece, determining whether the identification numbers of the mounted tool and the required tool are the same, changing the mounted tool to the required tool when the identification numbers of the mounted tool and the required tool are not the same, and machining the workpiece with the mounted tool.

The exemplary method may further include identifying an identification number of a subsequently required tool when a subsequent machining work exist, wherein, after the identification number of a subsequently required tool is identified, the changing of the mounted tool to the required tool is proceeded to replace the mounted tool to the subsequently required tool

When the mounted tool does not exist in the identifying of the identification number of the mounted tool, a unique identification number implying no mounted tool may be designated.

The changing of the mounted tool to the required tool may include, returning the mounted tool to a corresponding magazine among the first and second magazines, when the mounted tool exists in the machining unit, and mounting the required tool from a corresponding magazine among the first and second magazines

In returning the mounted tool to the corresponding magazine, the mounted tool may be returned to the first magazine when the identification number of the mounted tool corresponds to the first tools, and the mounted tool may be returned to the second magazine when the identification number of the mounted tool corresponds to the second tools. In mounting the required tool from a corresponding magazine, the required tool may be retrieved to the first magazine when the identification number of the required tool corresponds to the first tools, and the required tool may be retrieved from the second magazine when the identification number of the required tool corresponds to the second tools

According to a tool changing system of a machining center and a method for controlling the same according to an exemplary embodiment, various types of tools may be automatically handled for machining a workpiece, thereby reducing a cycle time and improving productivity.

In addition, different types of tools are arranged in different magazines disposed adjacent to a machining unit, thereby reducing an overall size and improving flexibility of a machining center.

In addition servo-motors are employed, and thereby changing of tools may become rapid and precise.

Further, effects that can be obtained or expected from exemplary embodiments of the present disclosure are directly or suggestively described in the following detailed description. That is, various effects expected from exemplary embodiments of the present disclosure will be described in the following detailed description.

### BRIEF DESCRIPTION OF THE DRAWINGS

FIG. 1 is a schematic diagram of a tool changing system of a machining center according to an exemplary embodiment.

FIG. 2 is a schematic diagram of a first magazine applied to a tool changing system of a machining center according to an exemplary embodiment.

FIG. 3 illustrates an operation of a tool changing portion applied in a tool changing system of a machining center according to an exemplary embodiment.

FIG. 4 is a schematic diagram of a second magazine applied to a tool changing system of a machining center according to an exemplary embodiment.

FIG. 5 is an enlarged view of a second magazine applied to a tool changing system of a machining center according to an exemplary embodiment, and illustrates an operation of the second magazine.

FIG. 6 is an exploded perspective view of a second magazine applied to a tool changing system of a machining center according to an exemplary embodiment.

FIG. 7 is a flowchart showing a method for controlling a tool changing system of a machining center according to an exemplary embodiment.

### DETAILED DESCRIPTION

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

The drawings and description are to be regarded as illustrative in nature and not restrictive, and like reference numerals designate like elements throughout the specification.

In the following description, dividing names of components into first, second and the like is to divide the names because the names of the components are the same as each other and an order thereof is not particularly limited.

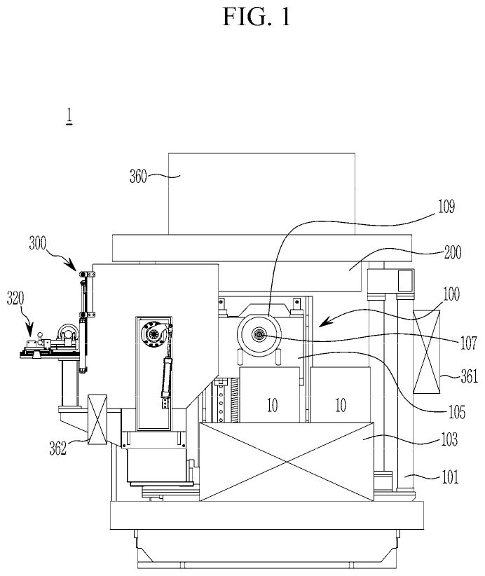

FIG. 1 is a schematic diagram of a tool changing system of a machining center according to an exemplary embodiment.

Referring to FIG. 1, a tool changing system 1 of a machining center according to an exemplary embodiment machines a workpiece, e.g., a part of a vehicle, by different types of works by using a plurality of tools having different sizes.

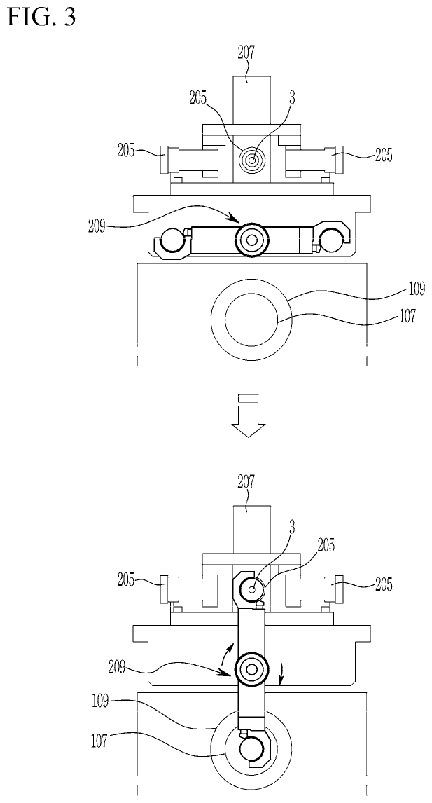

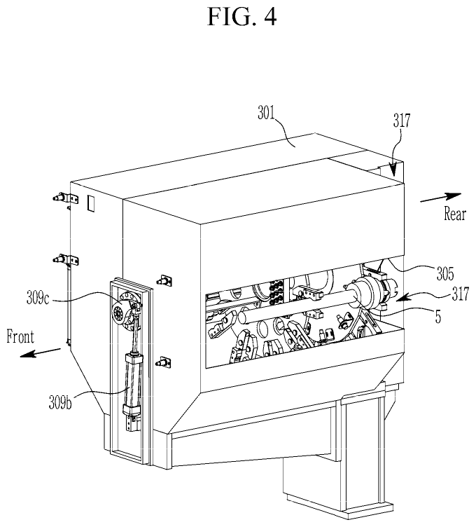

In the following description, a first tool 3 (refer to FIG. 3) and a second tool 5 (refer to FIG. 4) are taken as examples of tools used in the tool changing system 1 of a machining center.

That is, the first tool 3 and the second tool 5 are mere examples of various tools that may be required in machining the workpiece 10, and it is assumed that the second tool 5 is longer that the first tool 3.

The first tool 3 and the second tool 5 are assigned unique numbers, e.g., identification numbers, respectively.

For example, the first tool 3 may be assigned an identification number of from 1 to 10, and the second tool 5 may be assigned an identification number of from 11 to 20. Alternatively, the identification number of each tool may be encrypted.

Hereinafter, the term identification number is referred to as ID number.

The ID numbers of tools (i.e., the first tool 3 and the second tool 5) may be attached to the tools and be read or communicated by a controller in a known scheme. For example, the ID numbers may be marked to the tools in a bar code or an IC chip, and a controller may read the bar code or the IC chip to identify the ID numbers of the tools.

Typically, a vehicle length direction, i.e., a moving direction of a vehicle in an assembly line, is called a T direction, a vehicle width direction is called an L direction, and a vehicle height direction is called an H direction.

However, in an exemplary embodiment, front and rear, left and right, and up and down directions in FIG. 1 are taken as reference directions, instead of taking the LTH directions as reference directions.

In an exemplary embodiment, a first magazine 200 is disposed above a machining unit 100, and a second magazine 300 is disposed to the left of the machining unit 100.

It may be understood that the reference directions may have merely relative meanings, and directions of respective components of an exemplary embodiment may be altered.

A tool changing system 1 of a machining center according to an exemplary embodiment includes the machining unit 100, the first magazine 200, and the second magazine 300.

In a tool changing system 1 of a machining center according to an exemplary embodiment, the first magazine 200 may store the first tool 3, the second magazine 300 may store the second tool 5, and the machining unit 100 is supplied with the first tool 3 and the second tool 5 from the first magazine 200 and the second magazine 300, respectively.

The tool changing system 1 of a machining center may further include a controller 360 disposed above the first magazine 200, a first magazine control panel 361 connected to the first magazine 200, and a second magazine control panel 362 connected to the second magazine 300.

The controller 360 controls an overall operation of the first magazine 200 and the second magazine 300, the first magazine control panel 361 controls detailed operations and signals of the first magazine 200, and the second magazine control panel 362 controls detailed operations and signals of the second magazine 300.

The machining unit 100 is an apparatus where a workpiece requiring machining is placed and machined by using a plurality of tools, and is installed based on a base frame 101.

The machining unit 100 includes a jig portion 103 in which the workpiece 10 is loaded through the base frame 101.

The jig portion 103 may be a table on which the workpiece 10 is seated.

The workpiece 10 may be a part of a vehicle that requires machining.

The machining unit 100 includes a tool loading device 105 formed corresponding to the jig portion 103.

The tool loading device 105 is a device in which the first tool 3 and the second tool 5 for machining the workpiece are loaded, and includes an operation head 107 in which the first tool 3 and the second tool 5 are mounted, and a spindle 109 holding the operation head 107 rotatably and slidably.

The spindle 109 is configured to rotate and slide on the base frame 101.

The machining unit 100 may move up in the drawing in order to allow the operation head 107 to interact with the first magazine 200, and may move to the left in the drawing in order to allow the operation head 107 to interact with the second magazine 300. In order to machine the workpiece 10, the machining unit 100 may move to an appropriate position corresponding to a machining position for the workpiece 10, and then the spindle 109 may move forward while rotating.

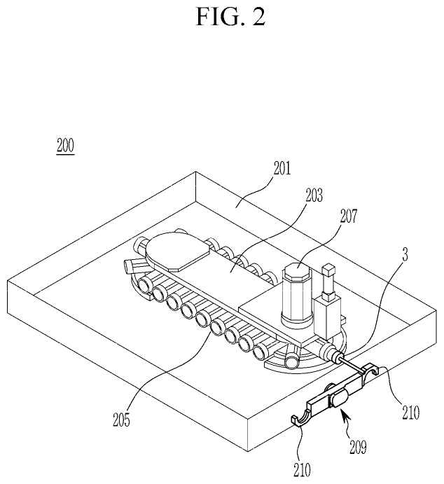

FIG. 2 is a schematic diagram of the first magazine 200 employed in a tool changing system 1 of a machining center according to an exemplary embodiment, and FIG. 3 illustrates an operation of a tool changing portion applied in a tool changing system of a machining center according to an exemplary embodiment.

As shown in FIG. 1, the first magazine 200 is disposed above the machining unit 100.

Referring to FIG. 2, the first magazine 200 is configured to accommodate a plurality of first tools 3 inside a first housing 201, and to selectively load a first tool 3 loaded at the tool loading device 105.

The first housing 201 is formed in a box shape at a position above the machining unit 100.

The first magazine 200 includes a plurality of holding members 205 inside the first housing 201 by a predetermined spacing, and the holding members 205 may revolve in a horizontal plane by a conveyor belt 203.

The holding member 205 may hold a head portion of the first tool 3 such that the first tool 3 is disposed in a horizontal direction.

The conveyor belt 203 mounted with the holding members 205 may revolve by a first servo-motor 207.

In addition, a rotatable changing device 209 is disposed in front of the first housing 201.

The rotatable changing device 209 may be disposed between the holding member 205 and the tool loading device 105.

Referring to FIG. 3, a central portion of the rotatable changing device 209 is rotatably mounted in the first housing 201, and a gripper 210 for gripping the first tool 3 is mounted to both ends of the rotatable changing device 209.

That is, the rotatable changing device 209 may rotate at the central portion, and thereby may exchange the first tools mounted at the holding member 205 and the operation head 107.

For example, the rotatable changing device 209 may include an automatic tool changer (ATC).

FIG. 4 is a schematic diagram of a second magazine applied to a tool changing system of a machining center according to an exemplary embodiment.

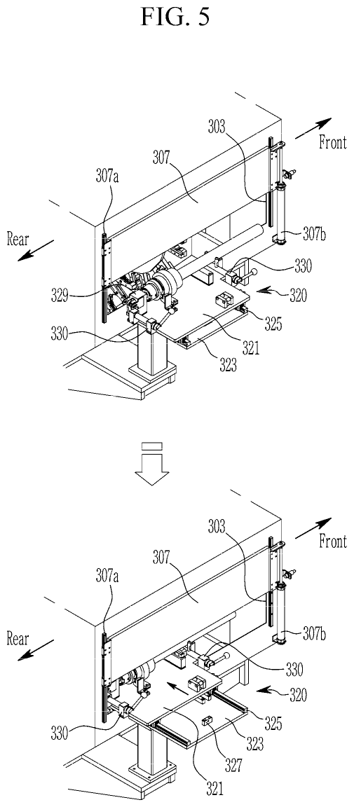

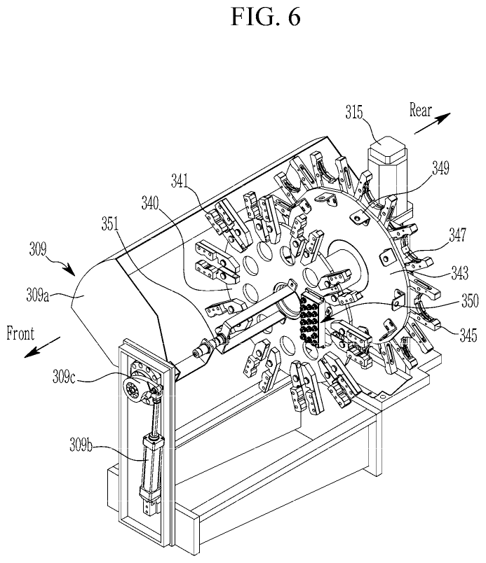

FIG. 5 is an enlarged view of a second magazine applied to a tool changing system of a machining center according to an exemplary embodiment, and illustrates an operation of the second magazine. FIG. 6 is an exploded perspective view of a second magazine applied to a tool changing system of a machining center according to an exemplary embodiment.

The second magazine 300 may be disposed to the left of the machining unit 100.

Referring to FIG. 4 to FIG. 6, the second magazine 300 is configured to store a plurality of second tools 5 in a second housing 301, and to load the second tool 5 to the tool loading device 105.

The second housing 301 is formed with a first opening 303 and a second opening 305.

More specifically, first opening 303 is formed on an exterior side that is distal from the machining unit 100, that is, at the left side with reference to FIG. 1, and the second opening 305 is formed on an interior side that is close to the machining unit 100, that is, at the right side with reference to FIG. 1.

By the second opening 305, a space portion 317 facing the machining unit 100 is formed in the second magazine 300 such that the tool loading device 105 may enter the space portion 317 to change tools

The second magazine 300 includes a slide cover 307 for opening and closing the first opening 303.

The slide cover 307 is installed at the first opening 303 of the second housing 301, and is configured to slidably move in up and down direction.

The slide cover 307 is fitted to guide members 307a on both sides, and may be mounted to be slidably moved in the up and down directions by an operation of a cylinder 307b.

In addition, the second magazine 300 includes a rotation cover 309 for opening and closing the second opening 305.

The rotation cover 309 is rotatably disposed in an interior of the second housing 301, such that the second opening 305 may be opened and closed by the rotation cover 309.

Both ends of the rotation cover 309 in the length direction are bent to from mounting ends 309a.

Thus, the rotation cover 309 may be rotatable through the mounting ends 309a that is rotatably mounted at the second housing 301, and thereby the rotation cover 309 may close and open the second opening 305.

Specifically, the mounting ends 309a of the rotation cover 309 is connected to a rotation member 309c that is connected to a cylinder rod of a cylinder 309b fixed to the second housing 301. By the operation of the cylinder 309b, the rotation member 309c is rotated and thereby the rotation cover 309 is then be rotated.

In addition, a tool seating part 320 is formed at a side surface of the second housing 301 corresponding to the first opening 303 (see FIG. 5).

The tool seating part 320 is for allowing the second tool 5 to get into the second housing 301.

That is, the tool seating part 320 allows a worker or a robot to seat the second tool 5 therein to enable the second tool 5 to easily get into the second housing 301. In more detail, after the second tool 5 is loaded to the tool seating part 320, the tool seating part 320 clamps the second tool 5 and moves the second tool 5 into the second housing 301.

The second tool 5 may be inserted into the second housing 301 by a slide operation of an upper plate 321 and a lower plate 323 of the tool seating part 320.

That is, the lower plate 323 is installed at the first opening 303 of the second housing 301, and the upper plate 321 is slidably mounted on the lower plate 323.

Rollers 325 are disposed at both sides between the upper plate 321 and the lower plate 323, and the upper plate 321 slides on the lower plate 323 through the rollers 325.

In addition, a stopper 327 is disposed at a location between the upper plate 321 and the lower plate 323, e.g., at a central end portion of the lower plate 323, and the stopper 327 may limit a slide movement of the upper plate 321.

A fixing part 329 may be formed on an upper surface of the upper plate 321, and the fixing part 329 may hold an end of the head portion of the second tool 5.

The fixing part 329 may include a catching portion 330 to rotate to tightly hold the head portion of the second tool 5.

The catching portion 330 may be provided in a plurality. That is, two catching portions 330 may be disposed at locations corresponding to a head portion and a body portion of the second tool 5.

Inside the second housing 301, a first rotation plate 340 and a second rotation plate 343 are disposed in parallel to each other.

The first rotation plate 340 is disposed in front of the second rotation plate 343, and the second rotation plate 343 is disposed at a rear of the first rotation plate 340.

The first rotation plate 340 and the second rotation plate 343 may clamp both ends of the second tool 5 supplied from the tool seating part 320, and may rotate together with the second tool 5.

Centers of the first rotation plate 340 and the second rotation plate 343 may be rotated by having their centers being connected to a rotation rod of a second servo-motor 315.

A plurality of first clamping members 341 are mounted at a predetermined interval along a circumference of the first rotation plate 340 and a plurality of second clamping members 345 are mounted at a predetermined interval along a circumference of the second rotation plate 343.

The clamping member mounted on the first rotation plate 340 is called the first clamping member 341, and the clamping member mounted on the second rotation plate 343 is called the second clamping member 345.

The first clamping member 341 clamps one side of the body portion of the second tool 5, and the second clamping member 345 clamps one side of the head portion of the second tool 5.

Ends of two fingers of each first clamping member 341 are hinged to the first rotation plate 340, and the two fingers of each first clamping member 341 may have free ends to clamp the body portion of the second tool 5.

In addition, each second clamping member 345 is rotatably mounted on the second rotation plate 343 through a connection bracket 347, in a state the two fingers of the second clamping member 345 are hinged to each other through the connection bracket 347. The two fingers of each second clamping member 345 may have free ends to clamp the head portion of the second tool 5.

A plurality of proximity sensors 349 are mounted on the second rotation plate 343, at respective positions corresponding to the second clamping members 345, so as to determine whether the respective second tools 5 are mounted.

The proximity sensor 349 may be mounted on the second rotation plate 343, more particularly, on a surface facing the first rotation plate 340.

The proximity sensor 349 may be wirelessly connected to a remote terminal 350 that mounted on the first rotation plate 340.

The proximity sensor 349 may send a signal regarding whether the second tool 5 is clamped or not, to the controller 360 through the remote terminal 350 by wireless communication. For example, a remote sensor 351 communicating with the controller 360 by wireless communication may be provided on a rotation axis of the first and second rotation plates 340 and 343, and the remote terminal 350 may send the signal to the controller 360 through the remote sensor 351.

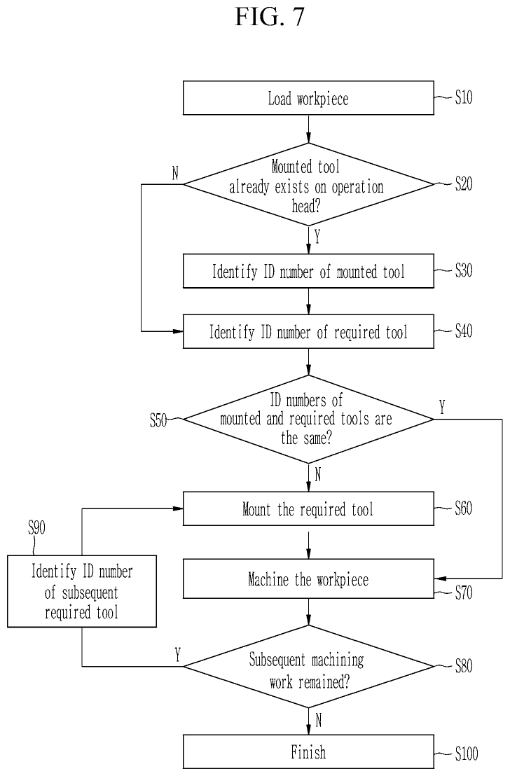

FIG. 7 is a flowchart showing a method for controlling a tool changing system of a machining center according to an exemplary embodiment.

A method for controlling a tool changing system of a machining center may be as follows.

Firstly at step S10, a workpiece 10 requiring machining is loaded to the jig portion 103 of the machining unit 100.

Then, the controller 360 may determine, at step S20, whether a mounted tool already exists on the operation head 107 of the tool loading device 105 of the machining unit 100. At this time, when the mounted tool does not exist, the controller 360 designates a unique ID number implying no mounted tool.

When there is the mounted tool already mounted to the operation head 107 of the tool loading device 105 (S20—Yes), the controller 360 may identify, at step S30, an ID number of the mounted tool.

When there is not a mounted tool already mounted to the tool loading device 105 (S20—No), or when the ID number of the mounted tool is identified at the step S30, the controller 360 may identify, at step S40, an ID number of a required tool required for machining the workpiece 10.

Subsequently at S50, the controller 360 determines whether the ID numbers of the mounted tool and the required tool are the same. It may be understood that, even if there is not a mounted tool at the operation head 107, the controller 360 may correctly determine whether the ID numbers of the mounted tool and the required tool are the same, since the unique ID number implying no mounted tool has been designated at the step S20.

When the ID numbers of the mounted tool and the required tool are the different (S50—No), the controller 360 mounts the required tool at the operation head 107 at step S60.

At the step S60, when the mounted tool exists at the operation head 107, the controller 360 firstly returns the mounted tool to a corresponding magazine, i.e., either to the first magazine 200 or the second magazine 300.

In more detail, when the ID number of the mounted tool corresponds to the first tool 3, the controller 360 returns the mounted tool of the first tool 3 mounted at the operation head 107 to the holding member 205 of the first magazine 200 by using the rotatable changing device 209 of the first magazine 200. When the ID number of the mounted tool corresponds to the second tool 5, the controller 360 returns the mounted tool of the second tool 5 mounted at the operation head 107 to the first rotation plate 340 and the second rotation plate 343 by moving the operation head 107 to the space portion 317 of the second magazine 300.

When the mounted tool has been returned to the corresponding magazine or when the mounted tool does not exist at the operation head 107, the controller 360 retrieves and mounts the required tool from a corresponding magazine, i.e., either from the first magazine 200 or the second magazine 300.

In more detail, when the ID number of the required tool corresponds to the first tool 3, the controller 360 retrieves the required tool of the first tool 3 from the holding member 205 of the first magazine 200 and mounts the required tool to the operation head 107 by using the rotatable changing device 209 of the first magazine 200. When the ID number of the required tool corresponds to the second tool 5, the controller 360 retrieves the required tool of the second tool 5 loaded at the first rotation plate 340 and the second rotation plate 343 and mounts the required tool to the operation head 107 by moving the operation head 107 to the space portion 317 of the second magazine 300.

When the mounted tool and the required tool belong to a same category, i.e., when both of the mounted tool and the required tool belong to the first tools 3 or to the second tools, changing of tools may be performed as follows.

When the ID numbers of the mounted tool and the required tool correspond to the first tool 3, the required tool of the first tool 3 is firstly placed at a changing position by rotating the holding member 205 mounting the required tool, and then the required tool at the holding member 205 and the mounted tool at the operation head 107 may be changed with each other simultaneously by using rotatable changing device 209 of the first magazine 200.

When the ID numbers of the mounted tool and the required tool correspond to the second tool 6, the controller 360 firstly moves the operation head 107 to the space portion 317 of the second magazine 300, and then returns the mounted tool to an empty place of the first rotation plate 340 and the second rotation plate 343. Then, the first rotation plate 340 and the second rotation plate 343 is rotated such that a corresponding second tool 5 having the ID number of the required tool is placed to a changing place, and then the corresponding second tool is mounted to the operation head 107.

When the required tool is mounted to the tool loading device 105, the controller 360 proceeds the machining of the workpiece 10 at step S70.

When the machining of the workpiece 10 is finished at the step S70, the controller 360 may determine, at step S80, whether a subsequent machining work to be performed exists. When the subsequent machining work to be performed does not exists (S80—Yes), the controller 360 may identify, at step S90, an ID number of the required tool for the subsequent machining work.

When the ID number of the required to for the subsequent machining work is identified at the step S90, the controller 360 proceeds to the step S60 to replace the currently mounted tool with the required tool for the subsequent machining work.

When the subsequent machining work to be performed does not exists (S80—No), the controller 360 finishes an entire machining process at step S100, by returning the mounted tool to an appropriate position.

According to a tool changing system of a machining center and a method for controlling the same according to an exemplary embodiment, various types of tools may be automatically handled for machining a workpiece 10, thereby reducing a cycle time and improving productivity.

According to a tool changing system of a machining center and a method for controlling the same, different types of tools are arranged in different magazines (e.g., the first magazine 200 and the second magazine 300) disposed adjacent to a machining unit, thereby reducing an overall size and improving flexibility of a machining center.

According to a tool changing system of a machining center and a method for controlling the same according to an exemplary embodiment, a first servo-motor 207 and a second servo-motor 315 are employed, and thereby changing of tools may become rapid and precise.

While the present disclosure has been described in connection with what is presently considered to be practical exemplary embodiments, it is to be understood that it is not limited to the disclosed embodiments. On the contrary, it is intended to cover various modifications and equivalent arrangements included within the spirit and scope of the appended claims.

What is claimed is:

1. A tool changing system of a machining center for machining a workpiece of a vehicle, comprising:
a machining unit including a jig portion for loading the workpiece and a tool loading device for loading a tool for machining the workpiece;
a first magazine for storing a plurality of first tools;
a second magazine for storing a plurality of second tools; and
a controller configured to manage changing of the first tool between the machining unit and the first magazine and changing of the second tool between the machining unit.

2. The tool changing system of claim 1, wherein:
each of the first tools and the second tools are respectively assigned an identification number; and
the second tools have lengths larger than the first tools.

3. The tool changing system of claim 1, wherein the tool loading device of the machining unit is disposed above the jig portion, and comprises:
an operation head for mounting a machining tool from among the plurality of first and second tools; and
a spindle for holding the operation head rotatably and slidably and disposed on a base frame rotatably and slidably.

4. The tool changing system of claim 1, wherein the first magazine comprises:
a first housing disposed above the machining unit;
a plurality of holding members for holding the plurality of first tools, disposed inside the first housing by a predetermined spacing, and revolving in a horizontal plane by a conveyor belt;
a first servo-motor for applying a driving torque to the conveyor belt; and
a rotatable changing device disposed in front of the first housing, disposed between the plurality of holding member and the tool loading device, and configured to replace tools between the tool loading device and the plurality holding members.

5. The tool changing system of claim 4, wherein:
a central portion of the rotatable changing device is rotatably mounted in the first housing; and
a gripper for gripping the first tool is mounted to both ends of the rotatable changing device.

6. The tool changing system of claim 1, wherein the second magazine comprises:
a second housing disposed lateral to the machining unit and having a first opening and a second opening at opposite sides
a tool seating part at a side of the second housing corresponding to the first opening and allowing the second tool to get into the second housing;
first and second rotation plates disposed in parallel to each other in an interior of second housing, and configured to clamp both ends of a second tool supplied from the tool seating part and to rotate together with the clamped second tool; and
a second servo-motor having a rotation rod connected to centers of the first and second rotation plates to apply a rotation torque to the first and second rotation plates.

7. The tool changing system of claim 6, wherein the second housing forms a space portion formed by the second opening to allow entrance of the tool loading device to change tools.

8. The tool changing system of claim 6, wherein the tool seating part comprises:
a lower plate installed at the first opening of the second housing;
an upper plate slidably mounted on the lower plate; and
a fixing part formed on an upper surface of the upper plate, and configured to hold an end of a head portion of the second tool.

9. The tool changing system of claim 8, wherein the fixing part comprises a catching portion to rotate to tightly hold the head portion of the second tool.

10. The tool changing system of claim 6, wherein:
a plurality of first clamping members are mounted at a predetermined interval along a circumference of the first rotation plate; and
a plurality of second clamping members are mounted at predetermined intervals along a circumference of the second rotation plate such that each second clamping member is rotatably mounted on the second rotation plate through a connection bracket.

11. The tool changing system of claim 10, wherein each of the plurality of first clamping members and the plurality of second clamping members each comprise finger members to clamp the second tool.

12. The tool changing system of claim 10, wherein:
the second magazine comprises a plurality of proximity sensors mounted on the second rotation plate, at respective positions corresponding to the plurality of second clamping members, so as to determine whether the second tool is mounted; and
the proximity sensor is configured to send a signal regarding whether the second tool is clamped or not, to the controller by wireless communication.

13. The tool changing system of claim 6, wherein the second magazine further comprises a rotation cover rotatably disposed in an interior of the second housing and configured to open and close the second opening.

14. A method for controlling a tool changing system of a machining center having a machining unit performing a machining work and having first and second magazines respectively storing first and second tools, the method comprising:
loading a workpiece to the machining unit;
identifying an identification number of a mounted tool mounted on the machining unit;
identifying an identification number of a required tool for machining the workpiece;
determining whether the identification numbers of the mounted tool and the required tool are the same;
changing the mounted tool to the required tool when the identification numbers of the mounted tool and the required tool are not the same; and
machining the workpiece with the mounted tool.

15. The method of claim 14, further comprising,
identifying an identification number of a subsequently required tool when a subsequent machining work exist,
wherein, after the identification number of a subsequently required tool is identified, the changing of the mounted tool to the required tool is proceeded to replace the mounted tool to the subsequently required tool.

16. The method of claim 14, wherein, when the mounted tool does not exist in the identifying of the identification number of the mounted tool, a unique identification number implying no mounted tool is designated.

17. The method of claim 14, the changing of the mounted tool to the required tool comprises:
returning the mounted tool to a corresponding magazine among the first and second magazines, when the mounted tool exists in the machining unit; and
mounting the required tool from a corresponding magazine among the first and second magazines.

18. The method of claim 17, wherein, in returning the mounted tool to the corresponding magazine, the mounted tool is returned to the first magazine when the identification number of the mounted tool corresponds to the first tools, and the mounted tool is returned to the second magazine when the identification number of the mounted tool corresponds to the second tools, and
wherein, in mounting the required tool from a corresponding magazine, the required tool is retrieved to the first magazine when the identification number of the required tool corresponds to the first tools, and the required tool is retrieved from the second magazine when the identification number of the required tool corresponds to the second tools.
